(19) United States
(12) Patent Application Publication
(10) Pub. No.: US 2009/0308288 A1
(43) Pub. Date: Dec. 17, 2009

(54) Vehicle steering wheel supported desk

(76) Inventor: Maurice Castellanos, Miami, FL (US)

Correspondence Address: Robert J. Van Der Wall;Suite 701, Grand Bay Plaza, 2665 South Bayshore Drive, Coconut Grove, FL, 33133, US

(21) Appl. No.: 12/214,041

(22) Filed: Jun. 17, 2008

(51) Int. Cl. B60N 3/00; A47B 17/06

(52) U.S. Cl. 108/44; 224/276

(57) ABSTRACT

The disclosure is for a vehicle steering wheel supported desk that provides a horizontal desk surface supported by a frame attached to a vehicular steering wheel regardless of the angle of the latter. It uses an infinitely variable angle adjuster to pivot the desk surface by rotating it about an axis connection to the frame attached to the vehicular steering wheel. The invention folds up compactly for storage when not in use and includes a handle and clamping means on the frame having a contoured radial configuration that matches the radius of the steering wheel to which the apparatus is attached, which includes rubber padded surfaces on the clamping means to both improve its grip of the steering wheel, and avoid damage to the steering wheel rim. The desk surface features a ribbed undersurface to make the desk surface both rigid and lightweight.

### BACKGROUND OF THE INVENTION

1. Field of the Invention

The present invention relates generally to the field of vehicular assessories, and specifically concerns a collapsible desk apparatus that is supported by a vehicular steering wheel. It is adjustable to render the desk surface horizontal regardless of the angle of the steering wheel, and is quickly attachable to and removable from the steering wheel.

2. Description of the Prior Art

It is known to attach writing surfaces to vehicular steering wheels, but most of these devices are constrained to a plane that is parallel to the plane of the steering wheel, whatever that happens to be. This almost always means that a user cannot release objects placed on that surface. While such a configuration may feasible for writing, it makes using the surface to eat essentially useless. Other prior art teach an adjustable surface to render it horizontal, but often lack a quick and foolproof attaching and releasing means, or have other deficiencies. Examples of the prior art follow: Morris, U.S. Pat. No. 2,211,962, teaches a Serving Tray, McGinley, U.S. Pat. No. 2,299,025, teaches a Steering Wheel Tray, Garrison, U.S. Pat. No. 2,299,025, teaches an Adjustable Tray for Automobile Steering Wheel, Vise, U.S. Pat. No. 3,643,606, teaches a Table Structure for Use in Motor Vehicles, Metcalf, U.S. Pat. No. 5,662,047, teaches a Steering Wheel Tray, and Lendl, U.S. Pat. No. 6,638,983, teaches a Table Arrangement for Motor Vehicles. All of these references lack a spring loaded contoured and padded clamping means for quick attachment to and detachment from the steering wheel while protecting it from scratching and other damage.

### SUMMARY OF THE INVENTION

Bearing in mind the foregoing, it is a principal object of the present invention to provide a horizontal desk surface supported by a frame attached to a vehicular steering wheel.

It is another principal object of the present invention to provide the foregoing capability regardless of the angle of steering wheel.

A related object of the invention is use a spring loaded push button to adjust the desk surface by rotating about a piano hinge connection to the frame attached to the vehicular steering wheel.

An additional object of the present invention is to provide a vehicular desk that folds up compactly for storage when not in use.

It is a further object of the present invention to provide all of the foregoing objects and advantages in combination with a quick and foolproof means for attaching the frame of the inventive apparatus to a supporting steering wheel and releasing the apparatus in the same manner.

A related object of the present invention to provide clamping means on the frame having a contoured radial configuration that matches the radius of the steering wheel to which the apparatus is attached.

A further related object of the present invention is to provide rubber padded surfaces on the clamping means to both improve its grip of the steering wheel, and avoid damage to the steering wheel rim.

Another object of the invention is to employ a hollow and ribbed member for the desk surface to make the apparatus both strong and lightweight.

Other objects and advantages will become apparent to those skilled in the art upon reference to the following descriptions and the appended drawings.

In accordance with a principal aspect of the invention there is provided a vehicle steering wheel supported desk that provides a horizontal desk surface supported by a frame attached to a vehicular steering wheel regardless of the angle of the latter. It uses a spring loaded push button to infinitely adjust the desk surface by rotating it about an axis connection to the frame attached to the vehicular steering wheel. The invention folds up compactly for storage when not in use and includes an innovative quick and foolproof means for attaching the frame of the inventive apparatus to a supporting steering wheel and releasing the apparatus in the same manner. It is a clamping means on the frame having a contoured radial configuration that matches the radius of the steering wheel to which the apparatus is attached, which includes rubber padded surfaces on the clamping means to both improve its grip of the steering wheel, and avoid damage to the steering wheel rim. The desk surface features a hollow and ribbed structure to make the apparatus both strong and lightweight. Finally, the invention includes a multi-purpose handle for carrying the invention when collapsed, for attaching the invention to the steering wheel, and for detaching it therefrom.

### BRIEF DESCRIPTION OF THE DRAWINGS

Various other features of the invention will become apparent to those skilled in the art from the following discussion taken in conjunction with the appended drawings, in which:

FIG. 1 is a perspective view of the preferred embodiment of the present invention.

FIG. 2 is a top plan view showing padded spring loaded contoured clamping means for attachment of the invention to the steering wheel.

### DETAILED DESCRIPTION OF THE PREFERRED EMBODIMENTS

As required, detailed embodiments of the present invention are disclosed herein; however, it is to be understood that the disclosed embodiments are merely exemplary of the invention which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

Reference is now made to the drawings, wherein like characteristics and features of the present invention shown in the various figures are designated by the same reference numerals.

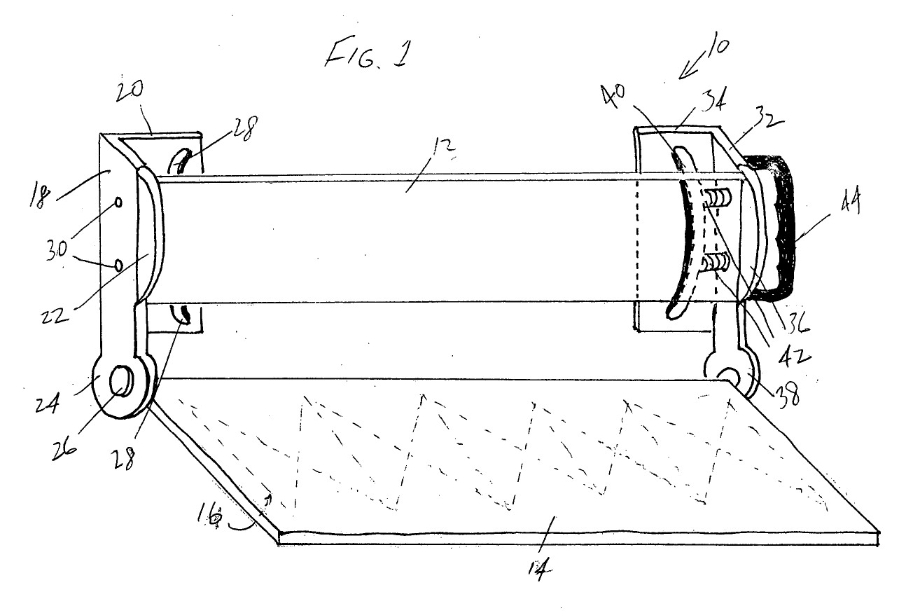

FIG. 1 is a perspective view of the preferred embodiment of the vehicle steering wheel supported desk 10. In the center are cross member 12, pivoting desk surface 14, and ribbed undersurface 16. On the left side it is comprised of left end element 18, left protective flange 20, left retainer 22, left axis cowl 24, push button angle adjuster 26, left contoured and padded clamping means 28 and left mounting points 30. On the right side, it is comprised of right end element 32, right protective flange 34, right retainer 36, right axis cowl 38, right side spring loaded contoured and padded clamping means 40, spring loaded mounting pins 42 and handle 44. The cross member and left and right end elements together comprise the frame of the invention. The push button angle adjuster is infinitely variable and permits the user to position the pivoting desk surface horizontally regardless of the angle of the steering wheel by which it is supported.

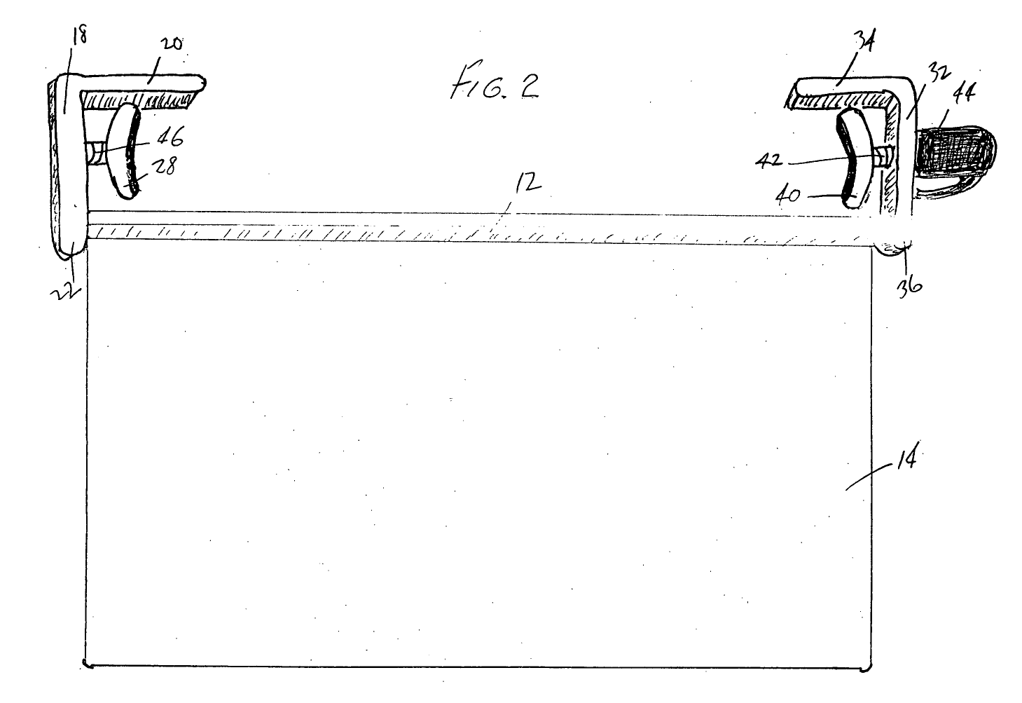

FIG. 2 is a top plan view showing cross member 12, pivoting desk surface 14, left end element 18, left protective flange 20, left retainer 22, left contoured and padded clamping means 28, left mounting pins 46, right end element 32, right protective flange 34, right retainer 36, right side spring loaded contoured and padded clamping means 40, spring loaded mounting pins 42 and handle 44. The padded spring loaded contoured clamping means for attachment of the invention to the steering wheel is fixed on the left side and spring loaded on the right side.

The left and right protective flanges 20 and 34 provide security to the left and right contoured and padded clamping means 28 and 40 when the device is folded up (collapsed) and stored. The pivoting desk surface 14 is folded upward and rests between the left and right retainers 22 and 36 for carrying and storage. The handle is multi-purposed. It is for carrying the folded up device to and from storage, and it is for applying the invention to a steering wheel and removing it therefrom. As noted above the left side of the clamping means 28 is fixed in relation to the left end element 18, while the right side of the clamping means 40 is spring loaded.

While the invention has been described, disclosed, illustrated and shown in various terms or certain embodiments or modifications which it has assumed in practice, the scope of the invention is not intended to be, nor should it be deemed to be, limited thereby and such other modifications or embodiments as may be suggested by the teachings herein are particularly reserved especially as they fall within the breadth and scope of the claims here appended.

What is claimed is:

1. A vehicle steering wheel supported desk comprising:
a frame supporting an axis;
a desk surface that pivots about the axis;
an infinitely variable angle adjuster permitting the desk surface both to be positioned horizontally regardless of the steering wheel angle and to be folded up for carrying and storage; and
a pair of contoured clamping means supported by the frame for attachment of the frame to the steering wheel.

2. The steering wheel desk of claim 1 in which the contoured clamping means are padded to protect the steering wheel from damage.

3. The steering wheel desk of claim 1 in which the pivoting desk surface folds up for convenient carrying and storage.

4. The steering wheel desk of claim 3 in which the frame is comprised of a cross member fixedly attached to left and right end elements, the end elements each having a protective flange to secure the contoured clamping means, and retainers within which is disposed the pivoting desk surface when it is folded up.

5. The steering wheel desk of claim 4 which further comprises a handle attached to one of the end elements for carrying the desk when it is folded up, for attaching the frame of the desk to the steering wheel and for detaching the frame of the desk from the steering wheel.

6. The steering wheel desk of claim 1 in which the pivoting desk surface is ribbed on its underside to make it both rigid and lightweight.

7. A vehicle steering wheel supported desk comprising:
a frame supporting an axis, a desk surface having a ribbed undersurface that pivots about the axis, and padded contoured clamping means, the frame having a cross member fixedly attached to left and right end elements, the end elements each having a protective flange to secure the contoured clamping means, and retainers within which is disposed the pivoting desk surface when it is folded up;
an infinitely variable angle adjuster permitting the desk surface both to be positioned horizontally regardless of the steering wheel angle and to be folded up for carrying and storage; and
a handle attached to one of the end elements for carrying the desk when it is folded up, for attaching the frame of the desk to the steering wheel and for detaching the frame of the desk from the steering wheel.
